(19) United States
(12) Patent Application Publication
(10) Pub. No.: US 2016/0138858 A1
(43) Pub. Date: May 19, 2016

(54) REFRIGERATOR, TERMINAL, MANAGEMENT SYSTEM AND MANAGEMENT METHOD FOR REFRIGERATOR CONTENTS

(71) Applicant: BSH HAUSGERAETE GMBH, MUENCHEN (DE)

(72) Inventors: SONGTAO LU, CHUZHOU (CN); GUANGFEI XIE, CHUZHOU (CN)

(21) Appl. No.: 14/943,508

(22) Filed: Nov. 17, 2015

(30) Foreign Application Priority Data
Nov. 18, 2014 (CN) 201410660531.3

(51) Int. Cl. F25D 29/00; G10L 15/22

(52) U.S. Cl. CPC F25D 29/00; G10L 15/22; G10L 2015/223; F25D 2700/06; F25D 2500/06

(57) ABSTRACT

A contents management method for an item in the refrigerator includes: receiving voice information input by a user when detecting that a refrigerator door is opened, where the voice information includes basic item change information corresponding to a change operation of the item in the refrigerator by a user; and identifying the voice information input by the user, performing pretreatment to generate complete item change information corresponding to the change operation of the item in the refrigerator by the user, and transmitting the complete item change information to a terminal. This enables the terminal to generate contents management information after the item in the refrigerator has been changed. By using the refrigerator, the terminal, and the management system and the management method for an item in the refrigerator, it can be more convenient to perform intelligent management on the item in the refrigerator.

### CROSS-REFERENCE TO RELATED APPLICATION

This application claims the priority, under 35 U.S.C. §119, of Chinese application CN 2014 10660 531.3, filed Nov. 18, 2014; the prior application is herewith incorporated by reference in its entirety.

### BACKGROUND OF THE INVENTION

### Field of the Invention

The present invention relates to the technical field of content management, in particular, to a refrigerator, a terminal, and a management system and a management method for a item in the refrigerator.

A refrigerator, as a freezing apparatus capable of maintaining a constant low temperature, may be applicable to enable a item to stay in a constant low temperature state, and by setting different temperatures in the cabinet. The contents can be kept fresh, thereby extending a shelf life and bringing about great convenience to users, especially during the summer months, when the exterior temperature is relatively high.

Generally, a refrigerator may be filled with various contents. However, the various items generally have different shelf lives due to differences in aspects such as material and sealing, and there are also differences in the time when the items are placed in the refrigerator. To avoid expiration, a user needs to remember shelf lives and deposit times of the various items, or frequently check states of the items in the refrigerator, which brings about extremely great memory work and causes much inconvenience for the user.

For user-friendly, there are methods for managing an item in a refrigerator by using a mobile phone at present. For example, a name, a date of manufacture, a quantity/weight, or the like of an item are obtained by scanning a barcode on a package of the item by using a mobile phone. However, since the user is holding the item in hands and further needs to close a refrigerator door, it is very inconvenient to perform scanning by using the mobile phone. Moreover, sometimes the mobile phone is not around or is out of power, which may also lead to failure in obtaining information of the item in time.

### BRIEF SUMMARY OF THE INVENTION

It is accordingly an object of the invention to provide a refrigerator contents management system, which overcomes a variety of disadvantages associated with the heretofore-known devices of this general type and which makes it possible to perform intelligent management on an item in a refrigerator more conveniently.

With the above and other objects in view there is provided, in accordance with the invention, a contents management method for a refrigerator, the method comprising: receiving voice information input by a user when detecting that a refrigerator door is opened, the voice information including basic item change information corresponding to a change operation of an item in the refrigerator by a user; and

identifying the voice information input by the user, performing pretreatment to generate complete item change information corresponding to the change operation of the item in the refrigerator by the user, and transmitting the complete item change information to a terminal, to thereby enable the terminal to generate contents management information after the item in the refrigerator has been changed.

Optionally, the contents management information includes shelf life information and the management method further includes: outputting expiration alarm information to the user when detecting that the corresponding item reaches a preset expiration alarm time.

Optionally, the basic item change information corresponding to the change operation of the item in the refrigerator by the user includes: a class and a quantity/weight of the changed item when the refrigerator door is opened.

Optionally, the complete item change information includes: a change time of the item in the refrigerator; and a time when the refrigerator door is opened is obtained as the change time of the item in the refrigerator.

Optionally, the complete item change information includes the change time of the item in the refrigerator and the obtained shelf life of the changed ingredient.

Optionally, the shelf life of the changed item is a shelf life of the item input by the user by voice, or a shelf life of the item preset in the refrigerator.

Optionally, the shelf life of the item preset in the refrigerator is associated with whether the opened refrigerator door is a cooler door or a freezer door.

Optionally, the shelf life of the item preset in the refrigerator is associated with whether the item is intact.

Optionally, the change operation of the item in the refrigerator by the user includes at least one of the following: depositing an item and taking out an ingredient.

To solve the above problem, an embodiment of the present invention also provides a method for managing an item in a refrigerator by a terminal. The method includes:

receiving, from the refrigerator, complete item change information corresponding to a change operation of the item in the refrigerator by a user, where the complete item change information is generated by the refrigerator, according to voice information input by the user, when detecting that a refrigerator door is opened, and the voice information includes basic item information corresponding to the change operation of the item in the refrigerator by the user when the refrigerator door is opened; and

generating, according to the complete item change information, contents management information after the item in the refrigerator is changed.

Optionally, the contents management information includes shelf life information; and the method further includes: outputting expiration alarm information to the user when detecting that the corresponding item reaches a preset expiration alarm time.

Optionally, the basic item change information corresponding to the change operation of the item in the refrigerator by the user when the refrigerator door is opened includes: a class and a quantity/weight of the changed item when the refrigerator door is opened.

Optionally, the complete item change information includes: a change time of the item in the refrigerator.

Optionally, the complete item change information includes the change time of the item in the refrigerator and the obtained shelf life of the changed ingredient.

Optionally, the shelf life of the changed item is a shelf life of the item input by the user by voice, or a shelf life of the item preset in the refrigerator.

Optionally, the shelf life of the item preset in the refrigerator is associated with whether the opened refrigerator door is a cooler door or a freezer door.

Optionally, the shelf life of the item preset in the refrigerator is associated with whether the item is intact.

Optionally, the change operation of the item in the refrigerator by the user includes depositing an item and taking out an ingredient.

Optionally, the method further includes: receiving an contents management operation instruction input by the user and updating the contents management information.

Optionally, the method further includes: analyzing a dietary habit of the user to generate and output dietary habit reference information of the user according to the class of the item in the refrigerator and the change time of the item in the refrigerator based on user needs.

To solve the above problem, an embodiment of the present invention further provides a refrigerator. The refrigerator includes:

a refrigerator door state detecting unit, applicable to detect whether a refrigerator door is in an open state;

a voice information input unit, applicable to receive voice information input by a user when the refrigerator door state detecting unit detects that the refrigerator door is in the open state, where the voice information includes basic item change information corresponding to a change operation of an item in the refrigerator by the user;

a pretreatment unit, applicable to identify the voice information received by the voice information input unit and perform pretreatment to generate complete item change information corresponding to the change operation of the item in the refrigerator by the user; and

a first communication unit, applicable to transmit the information generated by the pretreatment unit to a terminal, so as to enable the terminal to generate contents management information after the item in the refrigerator is changed.

Optionally, the contents management information includes shelf life information.

Optionally, the basic item change information corresponding to the change operation of the item in the refrigerator by the user includes: a class and a quantity/weight of the changed item when the refrigerator door is opened.

Optionally, the complete item change information includes: a change time of the item in the refrigerator.

Optionally, the complete item change information includes the change time of the item in the refrigerator and the obtained shelf life of the changed ingredient.

Optionally, the shelf life of the changed item is a shelf life of the item input by the user by voice, or a shelf life of the item preset in the refrigerator.

Optionally, the shelf life of the item preset in the refrigerator is associated with whether the opened refrigerator door is a cooler door or a freezer door.

Optionally, the shelf life of the item preset in the refrigerator is associated with whether the item is intact.

To solve the above problem, an embodiment of the present invention further provides a terminal. The terminal includes:

a second communication unit, applicable to receive, from the refrigerator, complete item change information corresponding to a change operation of an item in the refrigerator by a user, where the complete item change information is generated by the refrigerator, according to voice information input by the user, when detecting that a refrigerator door is opened, and the voice information includes basic item information corresponding to the change operation of the item in the refrigerator by the user when the refrigerator door is opened;

a management information generating unit, applicable to generate, according to the complete item change information received by the second communication unit, contents management information after the item in the refrigerator is changed; and

a memory or storage unit, applicable to store the contents management information generated by the management information generating unit.

Optionally, the contents management information includes shelf life information; and the terminal further includes: an information output unit, applicable to output expiration alarm information to the user when determining, according to the contents management information stored in the storage unit, the corresponding item reaches a preset expiration alarm time.

With the above and other objects in view there is also provided, in accordance with the invention, a management system for an item in a refrigerator. The management system includes:

a refrigerator, applicable to receive voice information input by a user when detecting that a refrigerator door is opened, where the voice information includes basic item change information corresponding to a change operation of the item in the refrigerator by the user, identify the voice information input by the user, perform pretreatment to generate complete item change information corresponding to the change operation of the item in the refrigerator by the user, and transmit the complete item change information to a terminal; and

a terminal, applicable to generate, according to the complete item change information transmitted by the refrigerator, contents management information after the item in the refrigerator is changed.

As compared with the existing technology, the technical solutions of the embodiments of the present invention have the following advantages:

When detecting that the refrigerator door is opened, the refrigerator acquires basic item change information of an item in the refrigerator, generates corresponding complete item change information through identification and pretreatment, and transmits the complete item change information to the terminal, to cause the terminal to generate contents management information for performing contents management. By using the above contents management method, in one aspect, since basic change information of the item in the refrigerator is acquired by receiving a voice input, a user does not need to use an exclusive device to identify an item when putting the item in the refrigerator; and since the voice input is triggered when detecting that the refrigerator door is opened, the user can be prevented from forgetting to update change information of the item in the refrigerator. Therefore, it is convenient for the user to put the item in the refrigerator and accurately update the change information of the item in the refrigerator in time. In a second aspect, since the refrigerator is used as an information acquiring device only and the terminal is used as an intelligent management terminal, it is convenient for the user to learn about a condition of the item in the refrigerator in time and manage the item in the refrigerator timely and effectively.

Further, since the contents management information includes shelf life information, the terminal may output expiration alarm information to the user when it is detected that the corresponding item reaches the preset expiration alarm time, to notify the user of the same in time, so that the user can reasonably arrange an eating sequence of items to avoid item expiration.

Further, by obtaining a change in the class and the quantity/weight of the item in the refrigerator when the refrigerator door is opened and generating contents management information based on the above, the user learns about a condition of the item in the refrigerator in time by using a terminal, so that the user may purchase a needed item in time, thereby facilitating users life.

Further, the refrigerator automatically records a change time of the item in the refrigerator and generates a change time of the item in the refrigerator based on the above, so that the user does not need to input the change time of the item by voice, thereby further facilitating users life.

Further, by presetting shelf life information in the refrigerator, the user does not need to input the same piece by piece by voice, thereby making it convenient for the user. Moreover, the user may also input a shelf life of the item by voice, so as to enable the shelf life of the item to be more reflective of the quality of the ingredient.

A plurality of factors such as whether the item preservation means is cooling or freezing and the integrity of the item is taken into consideration in presetting of the shelf life of the ingredient. Therefore, the quality of the item can be reflected more accurately, and accurate alarm information can be provided for the user.

Further, since the refrigerator is used as an information acquiring device only, the generated complete item change information and contents management information can be saved on a terminal or a server. Therefore, even if the user changes the refrigerator, the rich contents management information formed by using the previous refrigerator and user dietary habit reference information generated accordingly can still be used, thereby bringing about great convenience to the user.

Other features which are considered as characteristic for the invention are set forth in the appended claims.

Although the invention is illustrated and described herein as embodied in a refrigerator, terminal, and management system and management method for refrigerator contents, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the

### BRIEF DESCRIPTION OF THE DRAWING

FIG. 1 is a flowchart of a management method for an item in a refrigerator according to an embodiment of the present invention;

FIG. 2 is a flowchart of another method for managing an item in a refrigerator by using a terminal according to an embodiment of the present invention;

FIG. 3 is a schematic structural diagram of a refrigerator according to an embodiment of the present invention;

FIG. 4 is a schematic structural diagram of a terminal according to an embodiment of the present invention; and

FIG. 5 is a schematic structural diagram of a management system for an item in a refrigerator according to an embodiment of the present invention.

### DETAILED DESCRIPTION

As described above, with respect to the problem that it is not convenient to manage an item in a refrigerator by scanning item information using a mobile phone, the embodiments of the present invention adopt a refrigerator to acquire change information of an item in a refrigerator by voice. Specifically, when it is detected that a refrigerator door is opened, first the refrigerator acquires basic item change information when the item in the refrigerator changes, further generates corresponding complete item change information through identification and pretreatment, and transmits the complete item change information to a terminal, so that the terminal generates contents management information, for contents management. By using the above contents management method, in one aspect, a user does not need to use an exclusive device to identify an item when putting the item in the refrigerator, and therefore it is convenient for the user to deposit the item in the refrigerator. In a second aspect, since the refrigerator is used as an information acquiring device only and the terminal is used as an intelligent management terminal, a condition of the item in the refrigerator can be learned about in time for managing the item in the refrigerator timely and effectively.

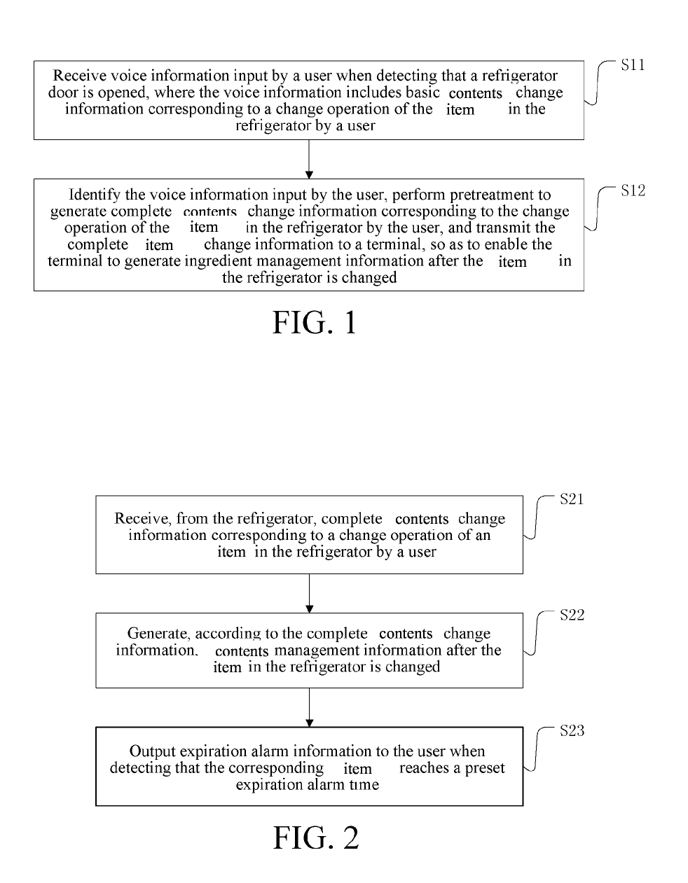

With reference to the flowchart of a management method for an item in a refrigerator according to an embodiment of the present invention, as shown in FIG. 1, detailed description is provided below with embodiments.

S11: Receive voice information input by a user when detecting that a refrigerator door is opened, where the voice information includes basic item change information corresponding to a change operation of the item in the refrigerator by a user.

In a specific implementation, a user opens a refrigerator door for depositing an ingredient, or for taking out an ingredient, or for taking out some items and also depositing some items. Correspondingly, the change operation of the item in the refrigerator by the user includes one of the following: depositing an item, taking out an ingredient, and taking out an item and depositing an ingredient. Further, the basic item change information corresponding to the change operation of the item in the refrigerator by the user includes: a class and a quantity/weight of the changed item when the refrigerator door is opened.

In an embodiment of the present invention, a user comes back after shopping in a supermarket and puts some items in the refrigerator. Once the refrigerator door is opened, a voice input function is triggered to receive a voice input from the user. For example, the user says: “Today, I bought half a pound of pork, two pounds of tomatoes, half a water melon, about three and a half pounds of eggs (or: two dozen eggs), several green vegetables, as well as a bag of bread and a bottle of Lao Gan Ma chilli sauce.”

In another embodiment of the present invention, a user takes out an item from the refrigerator. Once the user opens the refrigerator door, a voice input function is triggered. For example, the refrigerator outputs a voice: “Please tell me if you've taken out some food.” The user says: “I took out two eggs, two tomatoes, and all of the green vegetables.”

S12: Identify the voice information input by the user, perform pretreatment to generate complete item change information corresponding to the change operation of the item in the refrigerator by the user, and transmit the complete item change information to a terminal, so as to enable the terminal to generate contents management information after the item in the refrigerator is changed.

In a specific implementation, the complete item change information of the contents of the refrigerator obtained after the pretreatment may further include a change time of the item in the refrigerator apart from the basic item change information. The change time of the item in the refrigerator may be input by a user by voice, or may also be obtained by the refrigerator by using a clock provided in the refrigerator, or may be a time when the refrigerator door is opened that is obtained via a wireless network. For example, a time when it is detected that the refrigerator door is opened may be used as the change time of the item in the refrigerator. The refrigerator automatically records a change time of the item in the refrigerator, that is, a refrigerator door opening time, and generates a change time of the item in the refrigerator based on the above, so that the user does not need to input the change time of the item by voice, thereby making it more convenient for the user. It should be understood that, in a specific implementation, a time when the refrigerator door is closed may also be used as the change time of the item in the refrigerator. In the embodiments of the present invention, if not illustrated specifically, the time when the refrigerator door is closed is also used as one of refrigerator door opening times.

In a specific implementation, the refrigerator performs simple screening on the received voice information by identifying a keyword and coverts same into a digital signal through pretreatment, and then obtains complete item change information.

For example, with respect to the above “Today, I bought half a pound of pork, two pounds of tomatoes, half a watermelon, about three and a half pounds of eggs (or: two dozen eggs), several green vegetables, as well as a bag of bread and a bottle of Lao Gan Ma chili sauce”, information after pretreatment may be indicated as: “09:00, 18 Jun. 2014, deposit (+): 250 g of port, 1,000 g of tomatoes, 0.5 watermelon, 1750 g of eggs, ? green vegetables, ? bread, and 1 bottle of Lao Gan Ma chilli sauce”.

With respect to the above “I took out two eggs, two tomatoes, and all of the green vegetables”, information obtained after the pretreatment is as follows: “11:30, 18 Jun. 2014, take out (−): 2 tomatoes, 2 eggs, and all of green vegetables”.

After receiving the complete item change information of the item in the refrigerator, the terminal may perform corresponding processing to generate contents management information after the item in the refrigerator is changed.

The terminal, as an intelligent management terminal, may be a mobile terminal such as mobile phone, a laptop computer, a tablet computer, a PAD, and a car-carried terminal, or may also be a desktop computer or other intelligent terminals. By using the mobile terminal as the management terminal, it is convenient for a user to manage the item in the refrigerator at any time and any place.

In a specific implementation, according to needs, a user may use one terminal to manage an item in the refrigerator, or may also use a plurality of terminals to manage an item in the refrigerator. If a plurality of terminals is used, types of the terminals may be the same or may also be different. For example, one mobile phone and one computer may be simultaneously used as the terminals, or two mobile phones may also be used to manage an item in the refrigerator, or more or more types of terminals may also be used.

In an embodiment of the present invention, the complete item change information of the item in the refrigerator includes the change time of the item in the refrigerator and the obtained shelf life of the changed ingredient.

In a specific implementation, the contents management information includes shelf life information of the ingredient. In an embodiment of the present invention, the contents management information may include the complete item change information of the item in the refrigerator, which may be stored by means of a database in a specific implementation. Specific information of the item in the refrigerator may be indicated by means of a table in the contents management information, for example, a class, a weight, a quantity, have/none, deposit/take out (+/−), a total quantity, and optimal fresh-keeping days of the item may be included.

The optimal fresh-keeping days may be used as the shelf life of the ingredient. In a specific implementation, the shelf life of the changed item may be a shelf life of the item input by the user by voice, or may also be a shelf life of the item preset in the refrigerator. By presetting shelf life information in the refrigerator, the user does not need to input the same piece by piece by voice, thereby making it convenient for the user. Moreover, the user may also input a shelf life of the item by voice, so as to enable the shelf life of the item to be more reflective of the quality of the ingredient.

In a specific implementation, to reflect the quality of the item more accurately to provide accurate alarm information to a user, a plurality of actual factors that influence the shelf life of the item may be taken into consideration in the shelf life of the item preset in the refrigerator. In an embodiment of the present invention, the shelf life of the item is associated with whether the opened refrigerator door is a cooler door or a freezer door, that is, it is associated with whether the preservation means of the item is cooling or freezing. If being preserved by means of freezing, the shelf life may be set longer. In another embodiment of the present invention, the shelf life of the item preset in the refrigerator is associated with whether the item is intact. For example, the shelf life of half a watermelon is different from that of an intact watermelon. It should be understood that, in a specific implementation, the shelf life of the item may be set to be associated with both the preservation means of the item and the integrity of the ingredient.

In an embodiment of the present invention, after the two voice inputs, content of the contents management information formed in the database is shown in table 1, where “?” indicates that corresponding information is uncertain and that a user of the corresponding information may further input manually or by voice subsequently.

TABLE 1

| | | | | | Total | | |
|---|---|---|---|---|---|---|---|
| | Weight | Quantity | | Deposit/Take | quantity | Optimal fresh-keeping | |
| Ingredient | (g) | (number) | Have/None | out (+/−) | (number) | day(s) | |
| Pork | 250 | | Have | | Have | Depositing for 3 days | |
| | | | | | | and freezing for 8 days | |
| Tomato | 1000 | 18 | Have | −2 | 16 | 7 | days |
| Watermelon | | 0.5 | Have | | Have | 2 | days |
| Egg | 1750 | 28 | Have | −2 | 26 | 10 | days |
| Green vegetable | ? | ? | Have | — | None | 2 | days |
| Bread | ? | ? | Have | | Have | 4 | days |
| Chili sauce | | 1 | Have | | Have | 200 | days |

As can be seen from the above embodiments, since the refrigerator is used as an information acquiring device only and change information of an item in the refrigerator is acquired by receiving a voice input, a user does not need to use an exclusive device to identify an item when putting the item in the refrigerator; and since the voice input is triggered when detecting that the refrigerator door is opened, the user can be prevented from forgetting to update change information of the item in the refrigerator. Therefore, it is convenient for the user to put the item in the refrigerator and accurately update the change information of the item in the refrigerator in time. In a second aspect, since the refrigerator is used as an information acquiring device only and the terminal is used as an intelligent management terminal, it is convenient for the user to learn about a condition of the item in the refrigerator in time and manage the item in the refrigerator timely and effectively.

In addition, since the contents management information includes shelf life information, expiration alarm information may be output to the user when it is detected that the corresponding item reaches the preset expiration alarm time, to notify the user of the same in time, so that the user can reasonably arrange an eating sequence of items to avoid item expiration.

The embodiments of the present invention further provide a method for managing an item in a refrigerator by a terminal. Referring to FIG. 2, detailed description is provided below with specific steps.

S21: Receive, from the refrigerator, complete item change information corresponding to a change operation of an item in the refrigerator by a user.

In a specific implementation, the complete item change information is generated by the refrigerator, according to voice information input by the user, when detecting that a refrigerator door is opened, and the voice information includes basic item information corresponding to the change operation of the item in the refrigerator by the user when the refrigerator door is opened. The change operation of the item in the refrigerator by the user may be depositing an ingredient, or may also be taking out an ingredient, or may also be depositing some items and also taking out some items when the refrigerator door is opened.

In a specific implementation, as described in the foregoing embodiments, the basic item change information corresponding to the change operation of the item in the refrigerator by the user when the refrigerator door is opened may include: information such as a class and a quantity/weight of the changed item when the refrigerator door is opened.

In a specific implementation, the complete item change information of the item in the refrigerator may further include a change time of the item in the refrigerator apart from the basic item change information. The change time of the item in the refrigerator may be input by a user by voice, or may also be obtained by the refrigerator by using a clock provided in the refrigerator, or may be a time when the refrigerator door is opened that is obtained via a wireless network. For example, a time when it is detected that the refrigerator door is opened may be used as the change time of the item in the refrigerator. The refrigerator automatically records a change time of the item in the refrigerator, that is, a refrigerator door opening time, and generates a change time of the item in the refrigerator based on the above, so that the user does not need to input the change time of the item by voice, thereby making it more convenient for the user. It should be understood that, in a specific implementation, a time when the refrigerator door is closed may also be used as the change time of the item in the refrigerator. In the embodiments of the present invention, if not illustrated specifically, the time when the refrigerator door is closed is also used as one of refrigerator door opening times.

In a specific implementation, the complete item change information of the contens in the refrigerator may further include a change time of the item in the refrigerator and the obtained shelf life of the changed item apart from the basic item change information. In an embodiment of the present invention, the shelf life of the changed item may be a shelf life of the item input by the user by voice, or may also be a shelf life of the item preset in the refrigerator.

To reflect the quality of the item more accurately, a plurality of actual factors that influence the shelf life of the item may be taken into consideration in the shelf life of the item preset in the refrigerator.

For example, the shelf life of the item preset in the refrigerator may be associated with whether the opened refrigerator door is a cooler door or a freezer door. If being preserved by means of freezing, the shelf life may be set longer. In an embodiment of the present invention, if pork is preserved by cooling, the optimal fresh-keeping days, that is, the shelf life, may be set as 3 days, and if being preserved by freezing, the optimal fresh-keeping days may be set as 8 days.

For another example, the shelf life of the item preset in the refrigerator is associated with whether the item is intact. In an embodiment of the present invention, the optimal fresh-keeping days of half a watermelon are 2 days, and for an intact watermelon, the fresh-keeping days may be set as 5 days.

S22: Generate, according to the complete item change information, contents management information after the item in the refrigerator is changed.

In a specific implementation, the contents management information may include shelf life information. In an embodiment of the present invention, the contents management information includes the complete item change information of the item in the refrigerator, which may be stored by means of a database in a specific implementation. Specific information of the item in the refrigerator may be indicated by means of a table in the contents management information, for example, a class, a weight, a quantity, have/none, deposit/take out (+/−), a total quantity, and optimal fresh-keeping days of the item may be included, as shown in FIG. 1.

When the contents management information includes the shelf life information, the method for managing the item in the refrigerator by the terminal may further include the following step:

S23: Output expiration alarm information to the user when detecting that the corresponding item reaches a preset expiration alarm time.

As can be seen from the above embodiments, since the refrigerator is used as an information acquiring device only and the terminal is used as an intelligent management terminal to manage the item in the refrigerator, it is convenient for the user to learn about a condition of the item in the refrigerator at any time and any place and manage the item in the refrigerator timely and effectively.

The terminal, as an intelligent management terminal, may be a mobile terminal such as mobile phone, a laptop computer, a tablet computer, a PAD, and a car-carried terminal, or may also be a desktop computer or other intelligent terminals. By using the mobile terminal as the management terminal, it is convenient for a user to manage the item in the refrigerator at any time and any place.

In a specific implementation, according to needs, a user may use one terminal to manage an item in the refrigerator, or may also use a plurality of terminals to manage an item in the refrigerator. If a plurality of terminals is used, types of the terminals may be the same or may also be different. For example, one mobile phone and one computer may be simultaneously used as the terminals, or two mobile phones may also be used to manage an item in the refrigerator, or more or more types of terminals may also be used.

By monitoring shelf life information in the contents management information, expiration alarm information can be provided to the user at any time and any place when the corresponding item reaches a preset expiration alarm time. Therefore, the user can be notified of the same in time, so that the user can reasonably arrange an eating sequence of items to avoid item expiration.

In a specific implementation, to make it convenient for a user to better manage an item in a refrigerator to improve user experience, the above embodiments may be further extended. The following describes with examples.

In an embodiment of the present invention, a terminal receives data transmitted from a refrigerator for statistic processing and can display a temperature in the refrigerator in real time and detect a class, a quantity, quality, or the like of an item in the refrigerator.

In a specific implementation, if shelf life information of a corresponding item cannot be obtained from the refrigerator side, the terminal may use shelf life information of the corresponding item stored in the terminal, or may obtain shelf life information of the corresponding item from a server, to generate corresponding contents management information.

In a specific implementation, to avoid inaccuracy of voice monitoring, the terminal may receive an contents management operation instruction input by a user and update the contents management information according to the contents management operation instruction, so as to enable the user to manually interfere or update the contents management information, which includes a class, a quantity, a weight, shelf life information, or the like of an ingredient.

In a specific implementation, the terminal may further analyze a dietary habit of the user to generate and output dietary habit reference information of the user according to the class of the item in the refrigerator and the change time of the item in the refrigerator based on user needs. For example, by analyzing contents management information, a frequent shopping menu and shopping frequency of the user can be generated and output, dietary habit alarm information can also be generated to alert the user to pay attention to nutrition balance and control caloric intake, and specific advices for maintaining nutrition balance and controlling caloric intake can also be given. For example, during a segment of time, according to classes and quantities of items in the refrigerator, an advice of eating more of some items and fewer of other items is given, and some corresponding nutrition healthy recipes can also be provided. According to information such as the classes and quantities/weights of the items in the refrigerator, favorite recipes of the user can also be generated. In an embodiment of the present invention, the terminal may further output a recipe and an image-text course to the user according to the class of the item in the refrigerator. To better interact with a user, a recipe and an image-text course input by the user may also be received, so as to provide a richer variety of recipes and image-text courses to the user to improve user experience.

To make it convenient for a user to improve user experience, the terminal may also obtain geographic information near a position where the terminal is located, and if detecting that there is a supermarket in a preset range of area, outputs information of items that can be currently bought from the supermarket to the user, so as to enable the user to update the items in the refrigerator in time. For example, a user manages item information by using a mobile phone. When passing by a certain supermarket on the way home from work, the mobile phone carried on by the user outputs, according to classes and quantities of items in the refrigerator currently and classes, prices, or the like of items that can be currently bought from the supermarket, sales information of an item that can be bought from the supermarket with high cost-performance ratio and that may be short of in the refrigerator. It should be understood that some other factors, for example, user preferences, a current season, whether the nutrition is balanced, may also be considered when the terminal, such as the mobile phone, pushes information of items that can be currently bought from the supermarket to the user.

In a specific implementation, the terminal can also output some other information related to diets to a user to facilitate users life. Diet knowledge information may be output to a user, life tip information may also be output to a user, or diet knowledge information and life tip information are both output to a user.

In a specific implementation, to better satisfy user demands to improve user experience, information interaction may also be performed on information of the user that is associated with the refrigerator by using a terminal. In an embodiment of the present invention, the terminal may receive information that is input by a user and relates to the refrigerator and outputs feedback information that relates to the refrigerator to the user. For example, interaction may be performed with respect to the following aspects by using a terminal:

to contact customer service by using a terminal to reflect quality problem of a refrigerator, for example;

to feed back a product comment by using the terminal, for example, designs or services that can be further optimized in a contents management process; and

to receive a design solution from a user by using the terminal so as to enable the user to participate in product designing.

To enable persons skilled in the art to better understand and implement the present invention, detailed description of the refrigerator and the terminal for implementing the above contents management method is provided below with specific embodiments.

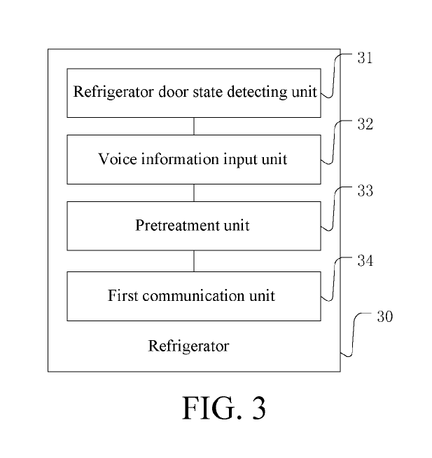

In an embodiment of the present invention, as shown in FIG. 3, a refrigerator 30 includes a refrigerator door state detecting unit 31, a voice information input unit 32, a pretreatment unit 33, and a first communication unit 34.

The refrigerator door state detecting unit 31 is applicable to detect whether a refrigerator door is in an open state.

The voice information input unit 32 is applicable to receive voice information input by a user when the refrigerator door state detecting unit 31 detects that the refrigerator door is in the open state, where the voice information includes basic item change information corresponding to a change operation of an item in the refrigerator by the user.

The pretreatment unit 33 is applicable to identify the voice information received by the voice information input unit 32 and perform pretreatment to generate complete item change information corresponding to the change operation of the item in the refrigerator by the user.

The first communication unit 34 is applicable to transmit the information generated by the pretreatment unit 33 to a terminal, so as to enable the terminal to generate contents management information after the item in the refrigerator is changed.

In a specific implementation, the basic item change information corresponding to the change operation of the item in the refrigerator by the user may include, for example, a class and a quantity/weight of the changed item when the refrigerator door is opened.

In an embodiment of the present invention, the complete item change information of the item in the refrigerator may include the change time of the item in the refrigerator.

In another embodiment of the present invention, the complete item change information of the item in the refrigerator may include the change time of the item in the refrigerator and the obtained shelf life of the changed ingredient. The shelf life of the changed item may be a shelf life of the item input by the user by voice, or may also be a shelf life of the item preset in the refrigerator.

In a specific implementation, to reflect the quality of the item more accurately, the shelf life of the item preset in the refrigerator may be associated with whether the opened refrigerator door is a cooler door or a freezer door, or may also be associated with whether the item is intact. It should be understood that, in a specific implementation, the shelf life of the item preset in the refrigerator may be reasonably set according to differences in characteristics and preservation conditions of specific items and other factors that may influence quality keeping.

In a specific implementation, the contents management information may include shelf life information. The terminal monitors the shelf life information and outputs expiration alarm information to the user when it is detected that the corresponding item reaches the preset expiration alarm time. For example, if the preset expiration alarm time is two days, expiration alarm information is output to a user if it is detected that there are two more days before the shelf life expiration, so that the user can reasonably arrange an eating sequence of items to avoid item expiration.

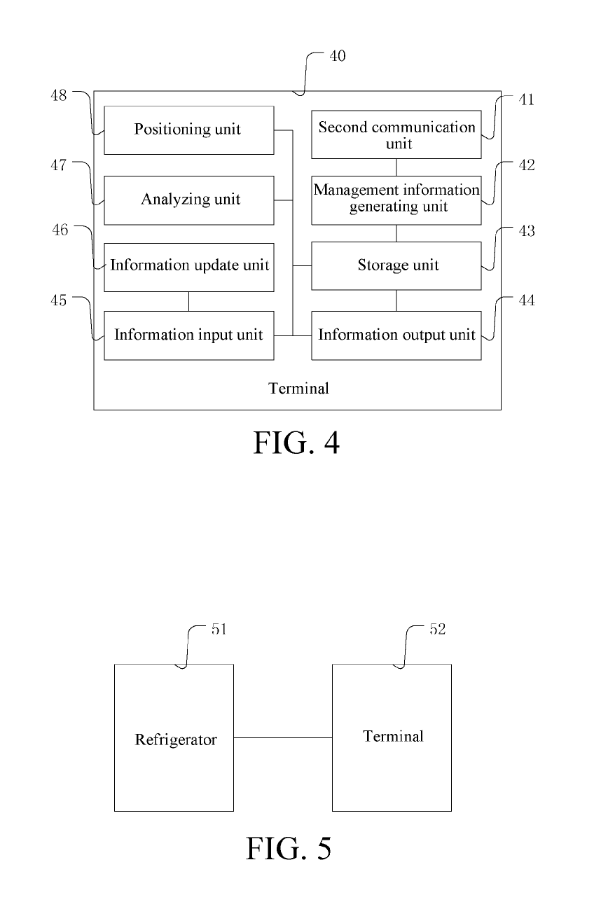

The embodiments of the present invention further provide a terminal for managing an item in a refrigerator. Referring to the schematic structural diagram of the terminal shown in FIG. 4, a terminal 40 may include: a second communication unit 41, a management information generating unit 42, a storage unit 43, and an information output unit 44.

The second communication unit 41 is applicable to receive, from the refrigerator, complete item change information corresponding to a change operation of an item in the refrigerator by a user, where the complete item change information is generated by the refrigerator, according to voice information input by the user, when detecting that a refrigerator door is opened, and the voice information includes basic item information corresponding to the change operation of the item in the refrigerator by the user when the refrigerator door is opened.

The management information generating unit 42 is applicable to generate, according to the complete item change information received by the second communication unit 41, contents management information after the item in the refrigerator is changed.

The storage unit 43 is applicable to store the contents management information generated by the management information generating unit 42.

By using the terminal as the intelligent management terminal, it is convenient for the user to learn about a condition of the item in the refrigerator at any time and any place and manage the item in the refrigerator timely and effectively.

In a specific implementation, the contents management information may include shelf life information. As shown in FIG. 4, the terminal 40 may further include: an information output unit 44, applicable to output expiration alarm information to the user when determining, according to the contents management information stored in the storage unit 43, the corresponding item reaches a preset expiration alarm time, so that the user can reasonably arrange an eating sequence of items to avoid item expiration.

In a specific implementation, as shown in FIG. 4, the terminal 40 may further include an information input unit 45 and an information update unit 46.

The information input unit 45 is applicable to receive information input by a user, including an management operation instruction.

The information update unit 46 is applicable to update, according to the contents management operation instruction received by the information input unit 45, contents management information stored in the storage unit. In a specific implementation, referring to FIG. 4, the terminal 40 may further include: an analyzing unit 47, applicable to analyze a dietary habit of the user to generate and output dietary habit reference information of the user, according to the contents management information stored in the storage unit 43, based on user needs. The information output unit 44 is further applicable to output the dietary habit reference information of the user generated by the analyzing unit.

In a specific implementation, the information output unit 44 is further applicable to output a recipe and an image-text course to the user according to the class of the item in the refrigerator.

In a specific implementation, the terminal 40 may further include: a positioning unit 48, applicable to detect whether there is a supermarket in a preset range of area. The information output unit 44 is further applicable to output, if the positioning unit 48 detects that there is a supermarket in the preset range of area, information of items that can be currently bought from the supermarket to the user.

In a specific implementation, to make it more convenient for a user to improve user experience, the information output unit 44 is further applicable to output, to the user, various types of life information, which may include, for example, at least one type of the following information: diet knowledge information and life tip information.

In a specific implementation, to enhance interaction to improve user experience, the information input unit 45 is further applicable to receive information that is input by a user and relates to the refrigerator; and the information output unit 44 is further applicable to output feedback information that relates to the refrigerator.

In a specific implementation, the terminal 40, as an intelligent management terminal, may be a mobile terminal such as mobile phone, a laptop computer, a tablet computer, a PAD, and a car-carried terminal, or may also be a desktop computer or other intelligent terminals. By using the mobile terminal as the management terminal, it is convenient for a user to manage the item in the refrigerator at any time and any place.

The embodiments of the present invention further provide a management system for an item in a refrigerator. As shown in FIG. 5, the management system for the item in the refrigerator may include: a refrigerator 51 and a terminal 52.

The refrigerator 51 is configured to receive voice information input by a user when detecting that a refrigerator door is opened, where the voice information includes basic item change information corresponding to a change operation of the item in the refrigerator by the user, identify the voice information input by the user, perform pretreatment to generate complete item change information corresponding to the change operation of the item in the refrigerator by the user, and transmit the complete item change information to a terminal; and

The terminal 52 is configured to generate, according to the complete item change information transmitted by the refrigerator 51, contents management information after the item in the refrigerator is changed.

In a specific implementation, to enable a user to reasonably arrange an eating sequence of items to avoid item expiration, the contents management information further includes shelf life information, and the terminal 52 outputs expiration alarm information to the user when detecting that a corresponding item reaches a preset expiration alarm time.

By using the above management system, since the refrigerator is used as an information acquiring device only and change information of an item in the refrigerator is acquired by receiving a voice input, a user does not need to use an exclusive device to identify an item when putting the item in the refrigerator; and since the voice input is triggered when detecting that the refrigerator door is opened, the user can be prevented from forgetting to update change information of the item in the refrigerator. Therefore, it is convenient for the user to put the item in the refrigerator and accurately update the change information of the item in the refrigerator in time. In a second aspect, since the refrigerator is used as an information acquiring device only and the terminal is used as an intelligent management terminal, it is convenient for the user to learn about a condition of the item in the refrigerator in time and manage the item in the refrigerator timely and effectively.

In a specific implementation, the management system may further include a server. The server is configured to receive complete item change information transmitted by the refrigerator, transmit the complete item change information to the terminal, and receive contents management information generated by the terminal.

The terminal, as an intelligent management terminal, may be a mobile terminal such as mobile phone, a laptop computer, a tablet computer, a PAD, and a car-carried terminal, or may also be a desktop computer or other intelligent terminals. By using the mobile terminal as the management terminal, it is convenient for a user to manage the item in the refrigerator at any time and any place.

In a specific implementation, according to needs, a user may use one terminal to manage an item in the refrigerator, or may also use a plurality of terminals to manage an item in the refrigerator. If a plurality of terminals is used, types of the terminals may be the same or may also be different. For example, one mobile phone and one computer may be simultaneously used as the terminals, or two mobile phones may also be used to manage an item in the refrigerator, or more or more types of terminals may also be used.

It should be noted that, in a specific implementation, to better improve user experience, persons skilled in the art can combine one or more solutions of the above embodiments, to enable a user to manage an item in a refrigerator more conveniently, which is not described in detail herein.

Persons of ordinary skill in the art should understand that all or a part of the steps of the respective methods according to the embodiments of the present invention may be implemented through a program instructing related hardware. The program may be stored in a computer readable storage medium including: an ROM, an RAM, a magnetic disk, an optical disk, or the like.

Although the present invention is disclosed as above, the present invention is not limited herein. Any person skilled in the art could make various modifications and amendments without departing from the spirit of the present invention. Therefore, the scope of protection of the present invention should be subject to the scope limited in the claims.

1. A contents management method for a refrigerator, the method comprising:
receiving voice information input by a user when detecting that a refrigerator door is opened, the voice information including basic item change information corresponding to a change operation of an item in the refrigerator by a user; and
identifying the voice information input by the user, performing pretreatment to generate complete item change information corresponding to the change operation of the item in the refrigerator by the user, and transmitting the complete item change information to a terminal, to thereby enable the terminal to generate contents management information after the item in the refrigerator has been changed.

2. The management method according to claim 1, wherein the contents management information comprises shelf life information and the management method further comprises: outputting expiration alarm information to the user when detecting that the corresponding item reaches a preset expiration alarm time.

3. The management method according to claim 2, wherein the basic item change information corresponding to the change operation of the item in the refrigerator by the user comprises: a class and a quantity/weight of the changed item when the refrigerator door is opened.

4. The management method according to claim 3, wherein the complete item change information comprises a change time of the item in the refrigerator; and the method comprises obtaining a time when the refrigerator door is opened as the change time of the item in the refrigerator.

5. The management method according to claim 3, wherein the complete item change information comprises: the change time of the item in the refrigerator and an obtained shelf life of the changed ingredient.

6. The management method according to claim 5, wherein the shelf life of the changed item is a shelf life of the item input by the user by voice, or a shelf life of the item preset in the refrigerator.

7. The management method according to claim 6, wherein the shelf life of the item preset in the refrigerator is associated with whether the opened refrigerator door is a cooler door or a freezer door.

8. The management method according to claim 6, wherein the shelf life of the item preset in the refrigerator is associated with whether or not the item is intact.

9. The management method according to claim 1, wherein the change operation of the item by the user comprises at least one of the following: depositing an item and taking out an ingredient.

10. A method for managing contents in a refrigerator by a terminal, the method comprising:
receiving, from the refrigerator, complete item change information corresponding to a change operation of the item in the refrigerator by a user, wherein the complete item change information is generated by the refrigerator, according to voice information input by the user when detecting that a refrigerator door is opened;
the voice information contains basic item information corresponding to the change operation of the item in the refrigerator by the user when the refrigerator door is opened; and
generating, according to the complete item change information, contents management information after the item in the refrigerator is changed.

11. The method according to claim 10, wherein the contents management information comprises shelf life information, and the method further comprises: outputting expiration alarm information to the user when detecting that the corresponding item reaches a preset expiration alarm time.

12. The method according to claim 11, wherein the basic item change information corresponding to the change operation of the item in the refrigerator by the user when the refrigerator door is opened comprises: a class and a quantity/weight of the changed item when the refrigerator door is opened.

13. The method according to claim 11, wherein the complete item change information comprises a change time of the item in the refrigerator.

14. The method according to claim 11, wherein the complete item change information comprises the change time of the item in the refrigerator and the obtained shelf life of the changed ingredient.

15. The method according to claim 14, wherein the shelf life of the changed item is a shelf life of the item input by the user by voice, or a shelf life of the item preset in the refrigerator.

16. The method according to claim 15, wherein the shelf life of the item preset in the refrigerator is associated with whether the opened refrigerator door is a cooler door or a freezer door.

17. The method according to claim 15, wherein the shelf life of the item preset in the refrigerator is associated with whether or not the item is intact.

18. The method according to claim 10, wherein the change operation of the item in the refrigerator by the user comprises depositing an item and taking out an ingredient.

19. The method according to claim 10, further comprising receiving a contents management operation instruction input by the user and updating the contents management information.

20. The method according to claim 10, further comprising analyzing a dietary habit of the user to generate and output dietary habit reference information of the user according to a class of the item in the refrigerator and the change time of the item in the refrigerator based on user needs.

21. A refrigerator, comprising:
a refrigerator door state detecting unit, configured to detect whether a refrigerator door is open;
a voice information input unit, configured to receive voice information input by a user when the refrigerator door state detecting unit detects that the refrigerator door open, the voice information containing basic item change information corresponding to a change operation of an item in the refrigerator by the user;
a pretreatment unit, configured to identify the voice information received by the voice information input unit and to perform pretreatment to generate complete item change information corresponding to the change operation of the item in the refrigerator by the user; and
a first communication unit, configured to transmit the information generated by the pretreatment unit to a terminal, so as to enable the terminal to generate contents management information after the item in the refrigerator is changed.

22. The refrigerator according to claim 21, wherein the contents management information comprises shelf life information.

23. The refrigerator according to claim 22, wherein the basic item change information corresponding to the change operation of the item in the refrigerator by the user comprises a class and a quantity/weight of the changed item when the refrigerator door is opened.

24. The refrigerator according to claim 22, wherein the complete item change information comprises a change time of the item in the refrigerator.

25. The refrigerator according to claim 22, wherein the complete item change information comprises the change time of the item in the refrigerator and the obtained shelf life of the changed ingredient.

26. The refrigerator according to claim 25, wherein the shelf life of the changed item is a shelf life of the item input by the user by voice, or a shelf life of the item preset in the refrigerator.

27. The refrigerator according to claim 26, wherein the shelf life of the item preset in the refrigerator is associated with whether the opened refrigerator door is a cooler door or a freezer door.

28. The refrigerator according to claim 26, wherein the shelf life of the item preset in the refrigerator is associated with whether or not the item is intact.

29. A terminal, comprising:
a communication unit, configured to receive, from a refrigerator, complete item change information corresponding to a change operation of an item in the refrigerator by a user, wherein the complete item change information is generated by the refrigerator, according to voice information input by the user, when detecting that a refrigerator door is opened, and the voice information contains basic item information corresponding to the change operation of the item in the refrigerator by the user when the refrigerator door is opened;
a management information generating unit, configured to generate, according to the complete item change information received by said communication unit, contents management information after the item in the refrigerator is changed; and
a memory unit, configured to store the contents management information generated by the management information generating unit.

30. The terminal according to claim 29, wherein the contents management information comprises shelf life information, and the terminal further comprises: an information output unit, configured to output expiration alarm information to the user when determining, according to the contents management information stored in the storage unit, that the corresponding item reaches a preset expiration alarm time.

31. A management system for an item in a refrigerator, comprising:
a refrigerator, configured to:
receive voice information input by a user when detecting that a refrigerator door is opened, wherein the voice information contains basic item change information corresponding to a change operation of the item in the refrigerator by the user,
identify the voice information input by the user,
perform pretreatment to generate complete item change information corresponding to the change operation of the item in the refrigerator by the user, and
transmit the complete item change information to a terminal; and
a terminal, configured to receive the complete item change information and to generate, according to the complete item change information received from by the refrigerator, contents management information after the item in the refrigerator has been changed.
